(19) United States
(12) Patent Application Publication
(10) Pub. No.: US 2023/0258894 A1
(43) Pub. Date: Aug. 17, 2023

(54) ASYMMETRIC INTERCONNECTION OF CONNECTORS

(71) Applicant: 3M INNOVATIVE PROPERTIES COMPANY, St. Paul, MN (US)

(72) Inventors: Changbao Ma, Austin, TX (US); Thomas Suniga, Austin, TX (US)

(21) Appl. No.: 18/015,821

(22) PCT Filed: Jul. 1, 2021
(86) PCT No.: PCT/IB2021/055938

§ 371 Date: Jan. 12, 2023

Related U.S. Application Data
(60) Provisional application No. 63/054,906, filed on Jul. 22, 2020.

(51) Int. Cl. G02B 6/42; G02B 6/38

(52) U.S. Cl. CPC G02B 6/4292; G02B 6/3882; G02B 6/3885; G02B 6/3893; G02B 6/4214

(57) ABSTRACT

An optical connector includes a housing and an optical ferrule configured to move relative to the housing. The optical ferrule is configured to mate with a mating optical connector which includes a mating housing and a mating optical ferrule fixed relative to the mating housing. The housing includes at least one first engagement feature for engaging a corresponding first mating engagement feature of the mating housing. The optical ferrule includes an input surface for receiving and transmitting a central light ray from an optical fiber, and a light redirecting side for receiving the central light ray and redirecting it along a different second direction, until it exits the optical ferrule through an output surface. When the optical connector moves to a full mating position relative to the mating optical connector, the transition causes the optical ferrule to move relative to the housing.

### SUMMARY

In some aspects of the present description, an optical connector is provided, including a housing and an optical ferrule housed in, and configured to move relative to, the housing. The optical ferrule is configured to mate with a mating optical connector, the mating optical connector including a mating housing and a mating optical ferrule housed in, and fixed relative to, the mating housing. The housing of the optical connector includes at least one first engagement feature for engaging a corresponding first mating engagement feature of the mating housing of the mating optical connector. The optical ferrule includes an input surface for receiving and transmitting a central light ray from an optical fiber attached to the optical ferrule, and a light redirecting side for receiving the central light ray transmitted along a first direction by the input surface and redirecting the received central light ray along a different second direction, such that the redirected central light ray exits the optical ferrule through an output surface of the optical ferrule. When the optical connector moves from a partial to a full mating position relative to the mating optical connector, the at least one first engagement feature transitions from engaging a first portion of the first mating engagement feature to a second portion of the first mating engagement feature. The transition causes the optical ferrule to move relative to the housing.

In some aspects of the present description, an optical connector is provided, including a housing and an optical ferrule housed in, and fixed relative to, the housing. The optical ferrule is configured to mate with a mating optical connector including a mating housing and a mating optical ferrule housed in, and configured to move relative to, the mating housing. The housing of the optical connector includes at least one first engagement feature for engaging a corresponding first mating engagement feature of the mating housing of the mating optical connector. The first engagement feature includes first and second portions. The optical ferrule includes an input surface for receiving and transmitting a central light ray from an optical fiber attached to the optical ferrule, and a light redirecting side for receiving the central light ray transmitted by the input surface along a first direction and redirecting the received central light ray along a different second direction. The redirected central light ray exits the optical ferrule through an output surface of the optical ferrule. When the optical connector moves from a partial to a full mating position relative to the mating optical connector, the first mating engagement feature transitions from engaging the first portion of the at least one first engagement feature to the second portion of the at least first engagement feature, the transition causing the mating optical ferrule to move relative to the mating housing.

In some aspects of the present description, an optical connector assembly is provided. including first and second optical connectors. The first optical connector includes a first housing and a first optical ferrule housed in, and configured to move relative to, the first housing. The second optical connector includes a second housing and a second optical ferrule housed in, and fixed relative to, the second housing. The first housing and the second housing each include respective first and second engagement features configured to engage each other. Each of the first optical ferrule and the second optical ferrules include an input surface for receiving and transmitting a central light ray from an optical component disposed proximate the optical ferrule, and a light redirecting side for receiving the central light ray transmitted by the input surface along a first direction and redirecting the received central light ray along a different second direction. The redirected central light ray exits the optical ferrule toward the other optical ferrule through an output surface of the optical ferrule. As the first and second optical connectors move from a partial mating position to a full mating position relative to each other, an engagement between the first and second engagement features transitions from a partial engagement to a full engagement, causing the first optical ferrule to move relative to the first housing.

### BRIEF DESCRIPTION OF THE DRAWINGS

FIG. 1 is a perspective view of an optical connector with a movable optical ferrule, in accordance with an embodiment of the present description;

FIG. 2 is a perspective view of an optical connector with a fixed optical ferrule, in accordance with an embodiment of the present description;

FIGS. 3A-3B provide cutaway views of optical ferrules of an optical assembly, in accordance with an embodiment of the present description;

FIGS. 4A-4B provide perspective views of an optical connector assembly in partial mating position, in accordance with an embodiment of the present description;

FIGS. 5A-5B provide perspective views of an optical connector assembly in full mating position, in accordance with an embodiment of the present description;

FIG. 6 is a cutaway view of a connector interfacing to an optical component via an optical fiber, in accordance with an embodiment of the present description;

FIG. 7 is a cutaway view of a connector interfacing directly to an optical component, in accordance with an embodiment of the present description; and

FIG. 8 is a cutaway view of two optical connectors in mating position, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Interconnections between optical components (e.g., connections between optical waveguides, such as optical fibers, and photonic circuits) may be done using one or more optical ferrules. In some embodiments, an optical ferrule receives an end of one or more optical fibers and holds those fibers in optical alignment with another optical component. Sometimes, a connection needs to be made between one optical ferrule (collecting a first set of optical waveguides) and another optical ferrule (collecting a second set of optical waveguides). To ensure proper optical alignment between the two mating ferrules, optical connectors are often designed such that, when they are fully mated, the optical fibers coming into each of the optical ferrules are at least slightly bent or curved, such that the bent optical fibers apply a continuous, forward pressure on the ferrules, holding them first in place in the mated position. The mating method in use today typically involves “symmetric” mating, in which each of the two optical ferrules to be mated are capable of moving relative to the connector housing which contains them, such that both sets of optical fibers are bent, providing pressure from both sides. However, by using an asymmetric mating scheme, in which one of the ferrules is fixed relative to its housing and the other ferrule is configured to move relative to its housing, the same results may be achieved using connectors which are less expensive and less complex.

According to some aspects of the present description, an optical connector includes a housing and an optical ferrule housed in, and configured to move relative to, the housing. In some embodiments, the optical ferrule may be configured to mate with a mating optical connector, the mating optical connector including a mating housing and a mating optical ferrule housed in, and fixed relative to, the mating housing. In some embodiments, the housing of the optical connector may include at least one first engagement feature for engaging a corresponding first mating engagement feature of the mating housing of the mating optical connector.

In some embodiments, the optical ferrule may include an input surface for receiving and transmitting a central light ray from an optical fiber attached to the optical ferrule. In some embodiments, the optical ferrule may further include a light redirecting side for receiving the central light ray transmitted along a first direction by the input surface. The light redirecting side may redirect the received central light ray along a different second direction as a redirected central light ray, such that the redirected central light ray exits the optical ferrule through an output surface of the optical ferrule.

In some embodiments, the optical connector may further include a plurality of optical fibers attached to the optical ferrule at a first location along a length of the optical fibers (e.g., a location near the input surface such that light from the optical fibers may be transmitted into the input surface along the first direction) and attached to the housing at a different second location along the length of the optical fibers.

In some embodiments, when the optical connector moves from a partial mating position to a full mating position relative to the mating optical connector, the at least one first engagement feature may transition from engaging a first portion of the first mating engagement feature to a second portion of the first mating engagement feature. The transition may cause the optical ferrule to move relative to the housing.

In some embodiments, the first engagement feature of the housing may be a protrusion protruding from an exterior surface of a sidewall of the housing. In some embodiments, the protrusion may protrude from the exterior surface of the housing along a direction that is substantially orthogonal to a mating direction of the optical connector. In some embodiments, the housing may have a pair of opposing first engagement features (e.g., a pair of protrusions), with each pair of first engagement features disposed on corresponding side walls of the housing. In some embodiments, the pair of first engagement features may be configured to engage a pair of corresponding opposing first mating engagement features of the mating housing of the mating optical connector.

In some embodiments, the first mating engagement feature of the mating housing of the mating optical connector may include an elongated opening defined in, and extending along, a sidewall of the mating housing. In some embodiments, the first mating engagement feature may define a first portion and a second portion. The first portion of the first mating engagement feature may be a first portion of the elongated opening which extends along the sidewall of the mating housing along a first direction. The second portion of the first mating engagement feature may be a second portion of the elongated opening which extends along the sidewall of the mating housing along a different second direction. In some embodiments, the elongated opening may have an open end and an opposing closed end, such that the elongated opening extends from the open end to the closed end.

In some embodiments, the optical ferrule rests on one or more supports of the housing. In some embodiments, when the at least one first engagement feature transitions (i.e., moves) from engaging the first portion of the first mating engagement feature to the second portion of the first mating engagement feature, the transition may cause the optical ferrule to separate from (e.g., lift off of) the supports.

It should be noted that terms including “optical connector”, “optical ferrule”, “housing”, “first engagement feature”, etc., when used herein without the modifying term “mating” are intended to describe elements of a first optical connector (a first optical ferrule, a first housing, etc.) The use of terms which are prefixed with or otherwise include the term “mating” (e.g., “mating optical connector”, “mating optical ferrule”, “mating housing”, “first mating engagement feature”, etc.) are intended to describe elements of a mating, or second, optical connector in an optical assembly. For example, an optical assembly according to the present description may include an optical connector (a first optical connector) and a mating optical connector (a second optical connector).

It should also be noted that the optical connector presented in the previous aspect was described as having an optical ferrule (i.e., a first optical ferrule) which was housed in, and configured to move relative to, its housing (i.e., a first housing), and that the mating optical connector had a mating optical ferrule (i.e., a second optical ferrule) which was described as housed in and fixed relative to the mating housing (i.e., a second housing). Said another way, the first optical ferrule was configured to move within its housing (the first housing) during a mating operation, and the second mating optical ferrule was configured to remain substantially fixed relative to the second mating housing during the mating operation.

In some embodiments, however, it may be desirable to swap the two connectors in the description, such that the first optical ferrule (in the first optical connector) is fixed relative to the first housing, and the second mating optical ferrule (in the second optical connector) is configured to move relative to the second mating housing. Although this alternate view or embodiment is substantially functionally similar to the previous aspect of the present description (but shown from a different perspective), it is provided here for completeness.

According to a second aspect of the present description, an optical connector includes a housing and an optical ferrule housed in, and fixed relative to, the housing. In some embodiments, the optical ferrule may be configured to mate with a mating optical connector including a mating housing and a mating optical ferrule housed in, and configured to move relative to, the mating housing.

In some embodiments, the housing of the optical connector may include at least one first engagement feature for engaging a corresponding first mating engagement feature of the mating housing of the mating optical connector. The first engagement feature may include first and second portions. The optical ferrule may include an input surface for receiving and transmitting a central light ray from an optical fiber attached to the optical ferrule, and a light redirecting side for receiving the central light ray transmitted by the input surface along a first direction and redirecting the received central light ray along a different second direction. The redirected central light ray may exit the optical ferrule through an output surface of the optical ferrule.

In some embodiments, the optical ferrule includes a first top surface portion which joins (i.e., extends between) the input surface of the optical ferrule and the light redirecting side of the optical ferrule. In some embodiments, the optical ferrule includes a second top surface portion which extends from the light redirecting side of the optical ferrule toward a front mating end of the optical ferrule. In some embodiments, the first top surface portion and the second top surface portion of the optical ferrule are bonded to the housing (i.e., adhere to and prevent motion relative to the housing).

When the optical connector moves from a partial to a full mating position relative to the mating optical connector, the first mating engagement feature may transition from engaging the first portion of the at least one first engagement feature to the second portion of the at least first engagement feature, causing the mating optical ferrule to move relative to the mating housing.

In some embodiments, the optical connector may further include a plurality of optical fibers attached to the optical ferrule. In some embodiments, an end face of each optical fiber may be disposed proximate to and facing the input surface of the optical ferrule. In some embodiments, at least for one of the optical fibers, an opposite end face of the optical fiber may be disposed proximate to an optical transceiver configured to receive light from and/or transmit light to the optical fiber. In some embodiments, the optical transceiver may include at least one of an optical detector (e.g., a light sensor) and a light source. In some embodiments, the optical connector may further include an optical transceiver disposed proximate to and facing the output surface of the optical ferrule and configured to receive light from and/or transmit light to the optical ferrule. That is, in some embodiments, the optical transceiver may be directly proximate the output surface of the optical ferrule, and may not interface with an intervening optical fiber.

According to some aspects of the present description, an optical connector assembly includes a first optical connector and a second optical connector. In some embodiments, the first optical connector may include a first housing and a first optical ferrule housed in, and configured to move relative to, the first housing. The second optical connector may include a second housing and a second optical ferrule housed in, and fixed relative to, the second housing. In some embodiments, the second optical ferrule may be bonded to the second housing.

In some embodiments, the first housing and the second housing each include respective first and second engagement features configured to engage each other. Each of the first optical ferrule and the second optical ferrule may include an input surface for receiving and transmitting a central light ray from an optical component disposed proximate the optical ferrule along a first direction, and a light redirecting side for receiving the central light ray transmitted by the input surface and redirecting the received central light ray along a different second direction. The redirected central light ray may exit the optical ferrule toward the other optical ferrule through an output surface of the optical ferrule. In some embodiments, the optical component may be an optical fiber attached to the optical ferrule. In some embodiments, the optical component may be an optical transceiver disposed proximate and facing the input surface of the optical ferrule and configured to receive light from and/or transmit light to the optical ferrule.

Stated another way, each of the first and second optical ferrules may include substantially similar optical paths such that, when in a mating position (e.g., inverted relative to one another with output surfaces adjacent one another), the first and second optical ferrules are in optical communication with each other. In some embodiments, the first engagement features may be different from but corresponding to the second engagement features, and configured to guide the first and second optical ferrules together and hold them in mating position.

As the first and second optical connectors move from a partial mating position to a full mating position relative to each other, an engagement between the first and second engagement features may transition from a partial engagement to a full engagement, causing the first optical ferrule to move relative to the first housing.

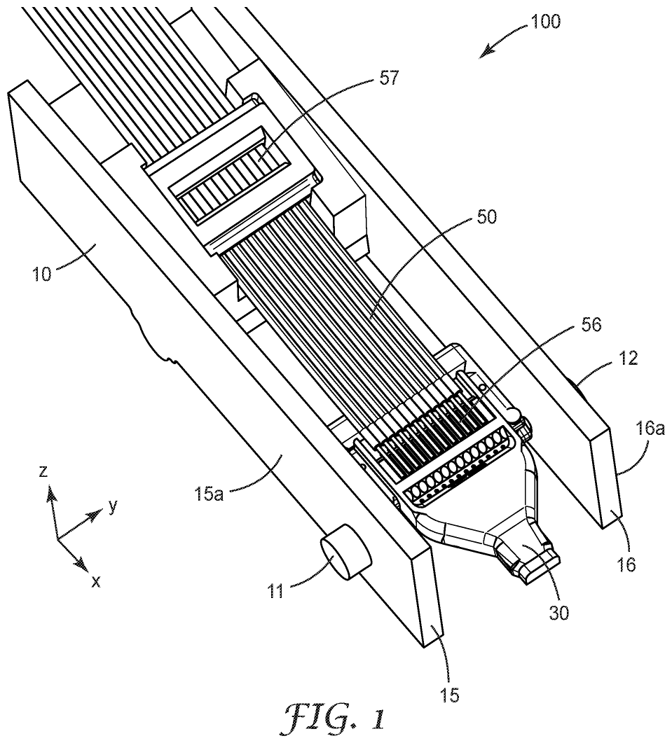

Turning now to the figures, FIG. 1 is a perspective view of an optical connector with a movable optical ferrule according to the present description. Optical connector 100 includes a housing 10 and an optical ferrule 30. The optical ferrule 30 includes one or more optical waveguides (e.g., optical fibers) 50 attached to the optical ferrule 30 at a first location 56. In some embodiments, the optical waveguides 50 are further attached to the housing 10 at a separate location 57. In some embodiments, the attachment of the optical waveguides 50 at location 57 may be fixed, such that the optical waveguides 50 are held firmly and not allowed to slide or translate relative to connection location 57.

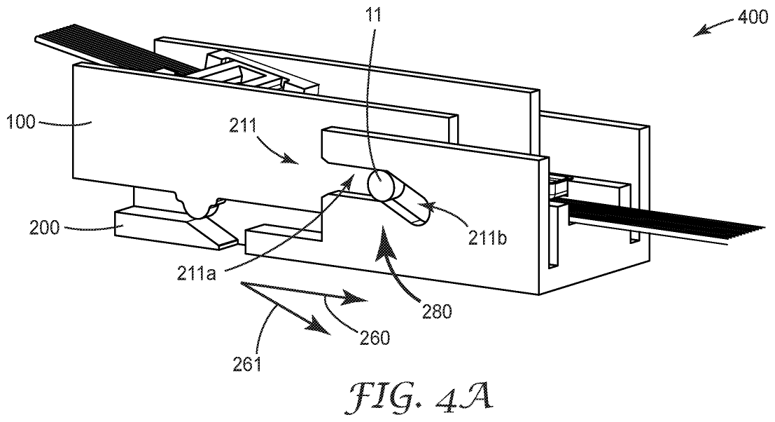

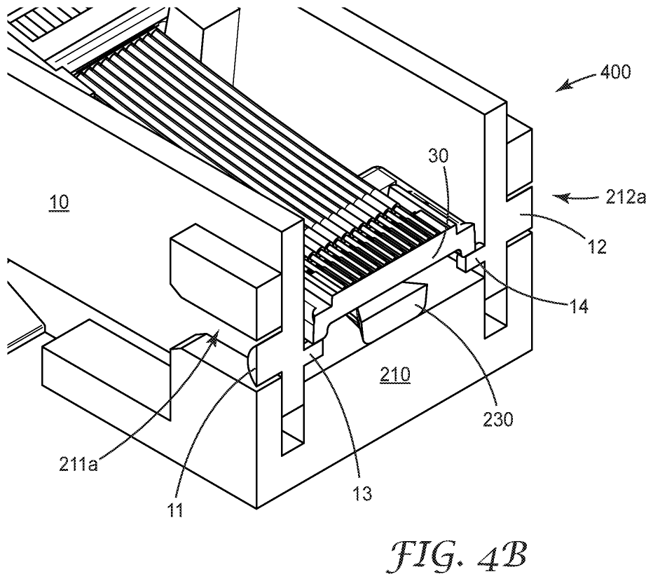

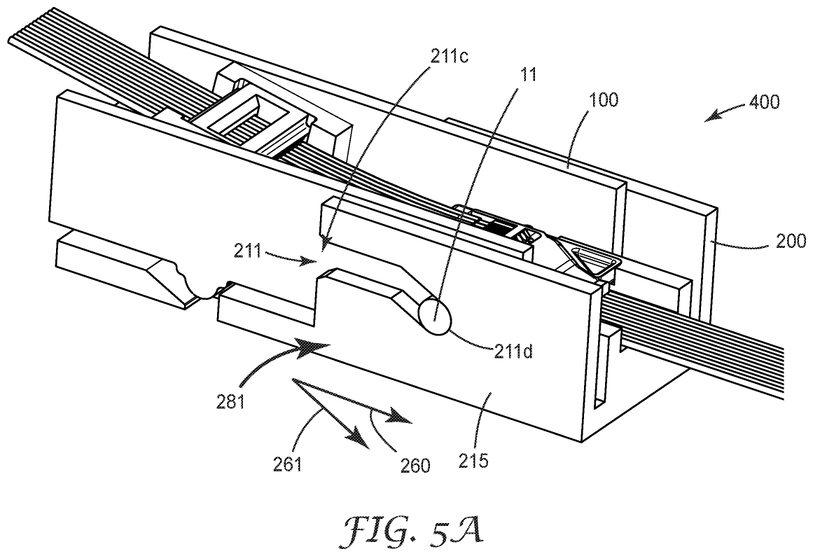

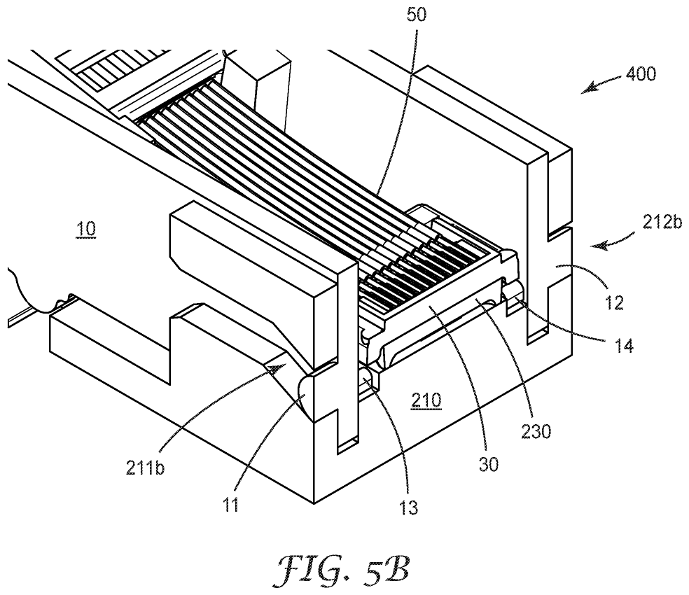

In some embodiments, optical ferrule 30 is disposed in housing 10 such that it is able to move relative to housing 10. For example, in some embodiments, optical ferrule 30 may “float” within housing 10, held in position only by the attached optical waveguides 50. In some embodiments, the floating optical ferrule 30 may rest on, but not be adhered to, supports (see, for example, supports 13 and 14 in FIGS. 4B and 5B, discussed elsewhere herein) when in an unmated state.

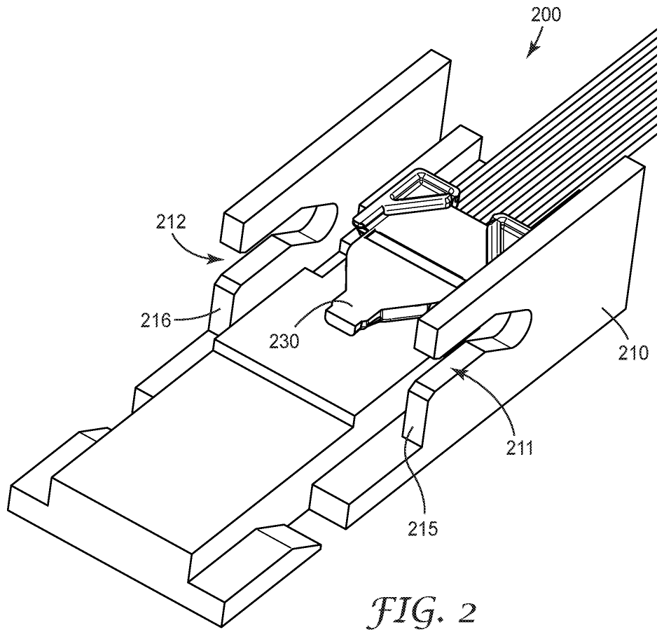

In some embodiments, housing 10 may include a pair of opposing sidewalls 15 and 16 with respective exterior surfaces 15a and 16a. In some embodiments, the housing 10 may include a pair of opposing first engagement features 11 and 12 disposed respectively on exterior surfaces 15a and 16a. In some embodiments, first engagement features 11 and 12 may include a protrusion protruding from the exterior surfaces 15a and 16a. In some embodiments, first engagement features 11, 12 may be configured to engage a corresponding pair of opposing first mating engagement features (see features 211 and 212, FIG. 2) of the mating housing (210, FIG. 2) of a mating optical connector (200, FIG. 2).

The connector embodiment shown in FIG. 1 is a first connector which, when properly mated with a corresponding mating connector, create an optical assembly according to an embodiment of the present description. FIG. 2 is a perspective view of an optical connector with a fixed optical ferrule, which may be mated with connector 100 shown in FIG. 1. Although, for the purposes of this discussion, optical connector 200 and its components may be described using the term “mating” (e.g., “mating optical connector 200”, “mating housing 210”, etc.), it is important to note that optical connector 100 may in some embodiments be considered to be the “mating” connector of optical connector 200. Stated another way, the term “mating” is used as a modifier to describe one of two optical connectors in a mating pair, and may at times be applied to either of the two connectors, depending on the focus of the current discussion. The modifier “mating” is not intended to be limiting in any way.

In some embodiments, mating optical connector 200 includes a mating housing 210 and a mating optical ferrule 230. In some embodiments, mating optical ferrule 230 is housed in, and fixed relative to mating housing 210. In some embodiments, the mating housing 210 includes two sidewalls 215, 216. In some embodiments, sidewalls 215 and 216 may each have a first mating engagement feature 211 and 212, respectively, configured to engage with first engagement features 11, 12 of optical connector 100 (FIG. 1). In some embodiments, first mating engagement features 211 and 212 may be elongated openings configured to accept first engagement features 11 and 12 and guide optical connector 100 into a mating position with mating optical connector 200.

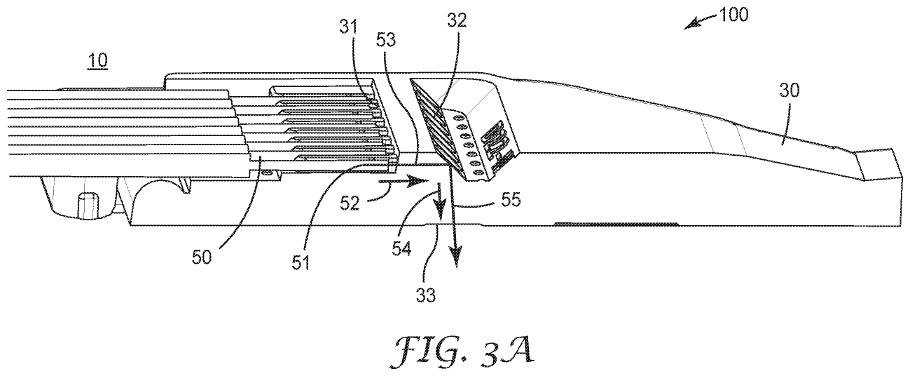

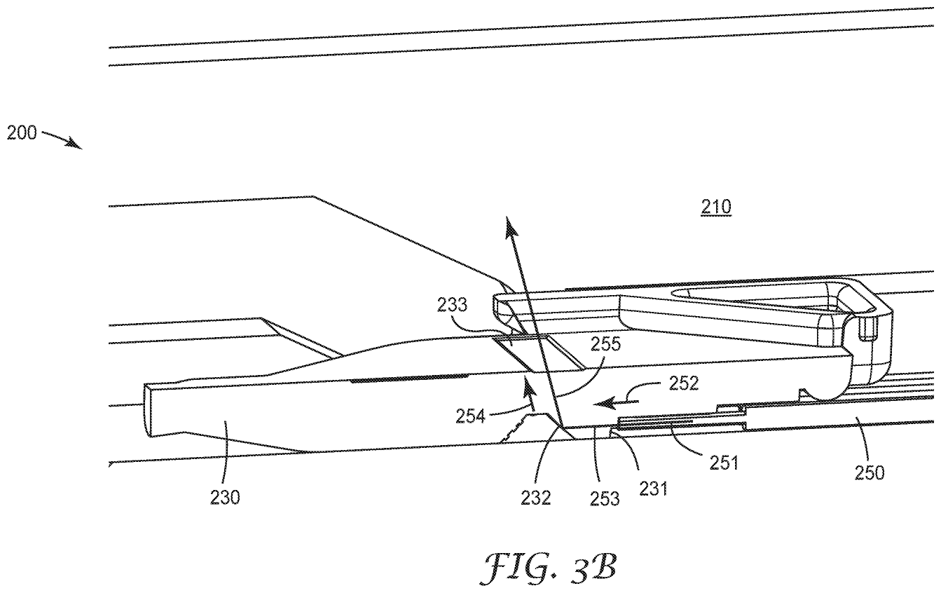

FIGS. 3A-3B provide cutaway views of optical ferrules of an optical assembly according to the present description. FIG. 3A provides a cutaway view of optical connector 100 including optical ferrule 30, and FIG. 3B provides a cutaway view of mating optical connector 200 and mating optical ferrule 230. In some embodiments, optical ferrule (first optical ferrule) 30 and mating optical ferrule (second optical connector) 230 may be substantially similar in configuration and function, and may be configured to mate with the same or similar surfaces adjacent to each other, such that optical ferrule 30 and mating optical ferrule 230 are “facing” each other, to create a complete optical path from one ferrule to the other.

Turning to FIG. 3A, first optical connector 100 includes a first housing 10 and a first optical ferrule 30 housed in, and configured to move relative to, first housing 10. In some embodiments, one or more optical waveguides (e.g., optical fibers) 50 are attached to first optical ferrule 30. In some embodiments, first optical ferrule 30 includes an input surface 31 for receiving and transmitting a central light ray 51 from optical fiber 50. In some embodiments, first optical ferrule 30 further includes a light redirecting side 32 for receiving central light ray 51 along first direction 52 and redirecting central light ray 51 in a different, second direction 54 as redirected central light ray 55. In some embodiments, redirected central light ray 55 exits first optical ferrule 30 through an output surface 33.

Turning now to FIG. 3B, second optical connector 200 includes a second housing 210 and a second optical ferrule 230 housed in, and fixed relative to, second housing 210. In some embodiments, one or more optical waveguides 250 are attached to second optical ferrule 230. In some embodiments, second optical ferrule 230 includes an input surface 231 for receiving and transmitting a central light ray 251 from optical fiber 250. In some embodiments, second optical ferrule 230 further includes a light redirecting side 232 for receiving central light ray 251 along first direction 252 and redirecting central light ray 251 in a different, second direction 254 as redirected central light ray 255. In some embodiments, redirected central light ray 255 exits second optical ferrule 230 through an output surface 233.

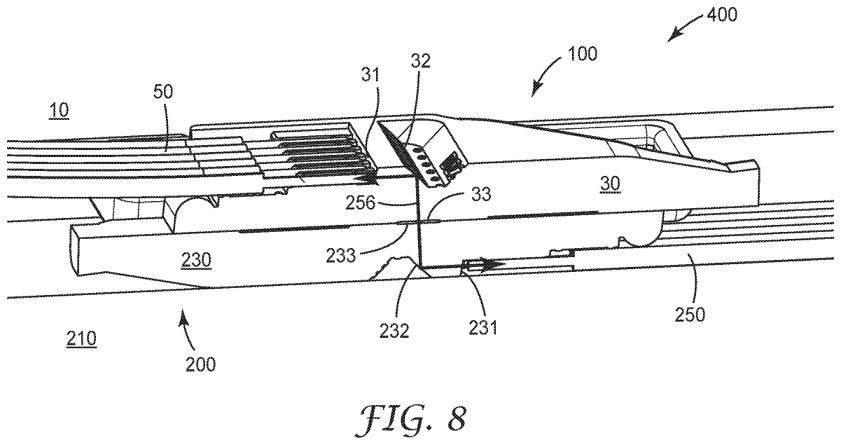

FIG. 8 provides a cutaway view of first optical connector 100 (FIG. 3A) and second optical connector 200 (FIG. 3B) in mating position, creating optical assembly 400. In some embodiments, output surface 233 of second optical ferrule 230 is adjacent to and facing output surface 33 of first optical ferrule 30, such that optical path 256 is established. Optical path 256 allows a light ray from optical waveguide 50 travel through the input surface 31 of first optical ferrule 30, be redirected by redirecting surface 32, and to exit output surface 33, where it then enters output surface 233 of second optical ferrule 230, is redirected by redirecting surface 232, and exits input surface 231 to enter optical light guide 250. Optical path 256 may be bidirectional, such that a light ray may travel in either direction, from first optical ferrule 30 to second optical ferrule 230, or from second optical ferrule 230 to first optical ferrule 30.

Returning now to FIGS. 4A-4B, these figures provide perspective views of optical connector assembly 400 in partial mating position (partial engagement position 280, also shown as Configuration A). In FIG. 4A first optical connector 100 is partially mated to second optical connector 200. First engagement feature 11 of first optical connector 100 is shown inserted into and partially mated with second engagement feature 211 of the second optical connector 200 (partial engagement position 280). In some embodiments, second engagement feature 211 (as well as opposing second engagement feature 212, not shown in FIG. 4A) is an elongated opening. In some embodiments, the elongated opening (second engagement feature 211) is divided into a first portion 211a and a second portion 211b, the first portion 211a extending in a first direction 260, and the second portion 211b extending in a different, second direction 262. As connector 100 is mated with connector 200, first engagement feature 11 enters first portion 211a of second engagement feature 211. First portion 211a guides the movement of first engagement feature 11 in first direction 260 until first engagement feature 11 leaves first portion 211a and moves into second portion 211b, where it is then guided in second direction 261.

FIG. 4B is a cutaway view of optical assembly 400 of FIG. 4A, showing additional detail. In the partially mated position shown (Configuration A), the first engagement features 11 and 12 rest in first portions 211a and 212a of second engagement features 211 and 212, respectively. In this position, optical ferrule 30 (which floats in and may move relative to housing 10) rests on supports 13 and 14, which help to guide optical ferrule 30 into position for eventual mating with mating (second) optical connector 230.

FIGS. 5A-5B provide perspective views of optical connector assembly 400 in full mating position (full engagement position 281, also shown as Configuration B). In FIG. 5A first optical connector 100 is fully mated to second optical connector 200. First engagement feature 11 of first optical connector 100 is shown inserted into and fully mated with second engagement feature 211 of the second optical connector 200 (full engagement position 281). In some embodiments, second engagement feature 211 is divided into a first portion and a second portion (portions 211a and 211b as shown in FIGS. 4A-4B), wherein the first portion is near open end 211c of second engagement feature 211, and the second portion is near closed end 211d. As connector 100 becomes fully engaged (fully mated) with connector 200, first engagement feature 11 travels through second engagement feature 211 from open end 211c, terminating at closed end 211d. This motion through second engagement feature 211 causes first engagement feature 11 to travel first in first direction 260 and then in second direction 261, the relative motion during mating causing first optical ferrule 30 and second optical ferrule 230 to engage in a full mated position (see FIG. 5B).

FIG. 5B is a cutaway view of optical assembly 400 of FIG. 5A, showing additional detail. In the fully mated position shown (Configuration B), the first engagement features 11 and 12 rest in second portions 211b and 212b of second engagement features 211 and 212, respectively. In this position, first optical ferrule 30 becomes fully engaged with second optical ferrule 230, and first optical ferrule 30 is lifted by (supported by and engaged with) second optical ferrule 230, and no longer rests on supports 13 and 14. When in fully mated Configuration B, the optical waveguides 50 may be flexed, putting positive forward pressure on first optical ferrule 30 and keeping it engaged with second optical ferrule 230.

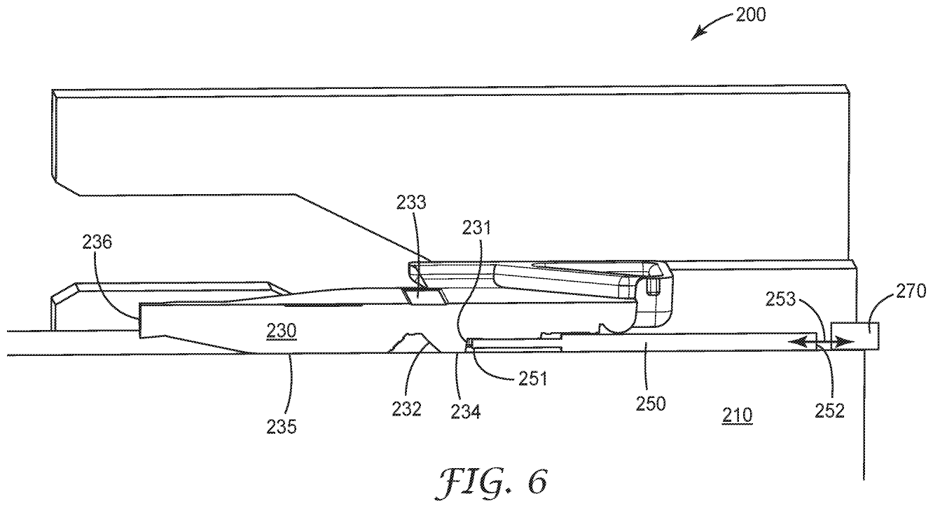

As the optical ferrule 230 in optical connector 200 shown in FIG. 2 is fixed in position relative to housing 210, optical ferrule 230 may interface to other optical components in a variety of ways. FIG. 6 is a cutaway view of one embodiment of optical connector 200 of FIG. 2, shown interfacing to an optical component via an optical fiber. Optical ferrule 230 is fixed to housing 210. An optical path is defined through optical ferrule 230 from input surface 231, to light redirecting side 232, and out through output surface 233. A first top surface portion 234 joins input surface 231 and light redirecting side 232, and a second top surface portion 235 extends from the light redirecting side 232 toward a front mating end 236 of optical ferrule 230. In some embodiments, first top surface portion 234 and second top surface portion 235 are bonded to housing 210. In the embodiment shown in FIG. 6, a plurality of optical fibers 250 attach to optical ferrule 230, such that an end face 251 of each optical fiber 250 is disposed proximate and facing input surface 231, and an opposite end face 252 of each optical fiber 250 is disposed proximate an optical transceiver 270. In some embodiments, the optical transceiver is configured to receive light 253 from and/or transmit light 253 to the optical fibers 250.

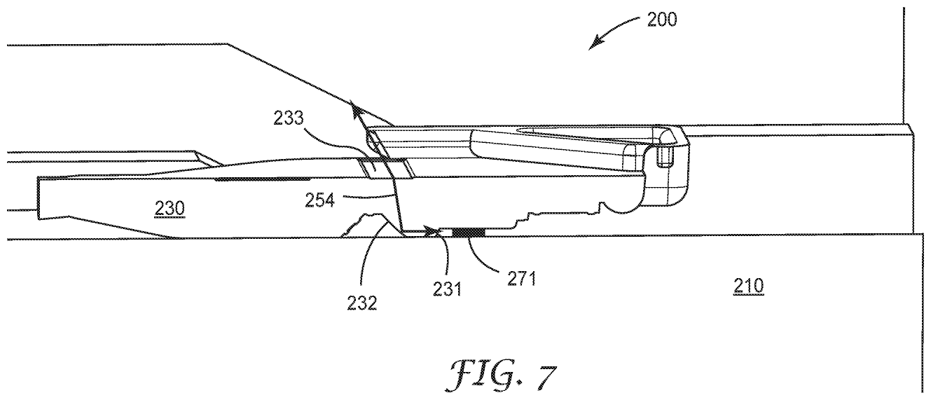

FIG. 7 is a cutaway view of an alternate embodiment of connector 200 of FIG. 2. In this embodiment, optical ferrule 230 is disposed such that input surface 231 is directly adjacent and facing an optical transceiver 271. In other words, in the embodiment of FIG. 7, no optical waveguides (e.g., optical fibers) connect the input surface 231 of the optical ferrule 230 and optical transceiver 271. Since optical ferrule 230 is fixed relative to housing 210, additional options for interfacing with optical components (such as this direct interface shown in FIG. 7) are possible, either not available to or easily implemented in a symmetric connector scheme, in which both ferrules in the mated pair may move relative to their respective housings. An optical path 254 may be defined from output surface 233, to light redirecting side 232, through input surface 231 to optical transceiver 271, as well as in the opposite direction.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. An optical connector comprising a housing and an optical ferrule housed in, and configured to move relative to, the housing, the optical ferrule configured to mate with a mating optical connector comprising a mating housing and a mating optical ferrule housed in, and fixed relative to, the mating housing, the housing comprising at least one first engagement feature for engaging a corresponding first mating engagement feature of the mating housing of the mating optical connector, the optical ferrule comprising an input surface for receiving and transmitting a central light ray from an optical fiber attached to the optical ferrule, a light redirecting side for receiving along a first direction, the central light ray transmitted by the input surface and redirecting the received light along a different second direction, the redirected central light ray exiting the optical ferrule through an output surface of the optical ferrule, such that:
when the optical connector moves from a partial to a full mating position relative to the mating optical connector, the at least one first engagement feature transitions from engaging a first portion of the first mating engagement feature to a second portion of the first mating engagement feature, the transition causing the optical ferrule to move relative to the housing.

2. The optical connector of claim 1, wherein the at least one first engagement feature comprises a protrusion protruding from an exterior surface of a sidewall of the housing along a direction substantially orthogonal to a mating direction of the optical connector.

3. The optical connector of claim 1, wherein the housing comprises a pair of opposing first engagement features disposed on corresponding pair of opposing sidewalls of the housing, the pair of opposing first engagement features configured to engage a pair of corresponding opposing first mating engagement features of the mating housing of the mating optical connector.

4. The optical connector of claim 1, wherein the first mating engagement feature of the mating housing of the mating optical connector comprises an elongated opening defined in, and extending along, a sidewall of the mating housing, wherein the first portion of the first mating engagement feature comprises a first portion of the elongated opening extending along the sidewall of the mating housing along a first direction and the second portion of the first mating engagement feature comprises a second portion of the elongated opening extending along the sidewall of the mating housing along a different second direction.

5. The optical connector of claim 4, wherein the elongated opening extends from an open end of the elongated opening to an opposing closed end of the elongated opening.

6. The optical connector of claim 1, wherein the optical ferrule rests on at least one support of the housing, and wherein when the at least one first engagement feature transitions from engaging the first portion of the first mating engagement feature to the second portion of the first mating engagement feature, the transition causes the optical ferrule to separate from the at least one support.

7. The optical connector of claim 1 further comprising a plurality of optical fibers attached to the optical ferrule at a first location along a length of the plurality of optical fibers and attached to the housing at a different second location along the length of the plurality of optical fibers.

8. An optical connector comprising a housing and an optical ferrule housed in, and fixed relative to, the housing, the optical ferrule configured to mate with a mating optical connector comprising a mating housing and a mating optical ferrule housed in, and configured to move relative to, the mating housing, the housing comprising at least one first engagement feature for engaging a corresponding first mating engagement feature of the mating housing of the mating optical connector, the first engagement feature comprising first and second portions, the optical ferrule comprising an input surface for receiving and transmitting a central light ray from an optical fiber attached to the optical ferrule, a light redirecting side for receiving along a first direction, the central light ray transmitted by the input surface and redirecting the received light along a different second direction, the redirected central light ray exiting the optical ferrule through an output surface of the optical ferrule, such that:
when the optical connector moves from a partial to a full mating position relative to the mating optical connector, the first mating engagement feature transitions from engaging the first portion of the at least one first engagement feature to the second portion of the at least first engagement feature, the transition causing the mating optical ferrule to move relative to the mating housing.

9. The optical connector of claim 8, wherein the optical ferrule comprises a first top surface portion joining the input surface and the light redirecting side, and a second top surface portion extending from the light redirecting side toward a front mating end of the optical ferrule, and wherein the first and second top surface portions of the optical ferrule are bonded to the housing.

10. The optical connector of claim 8 further comprising a plurality of optical fibers attached to the optical ferrule, an end face of each optical fiber disposed proximate and facing the input surface, wherein for at least one fiber, an opposite end face of the optical fiber is disposed proximate an optical transceiver configured to at least one of receive light from and transmit light to the optical fiber.

11. The optical connector of claim 10, wherein the optical transceiver comprises at least one of an optical detector and a light source.

12. The optical connector of claim 8 further comprising an optical transceiver disposed proximate and facing the input surface and configured to at least one of receive light from and transmit light to the optical ferrule.

13. An optical connector assembly comprising first and second optical connectors, the first optical connector comprising a first housing and a first optical ferrule housed in, and configured to move relative to, the first housing, the second optical connector comprising a second housing and a second optical ferrule housed in, and fixed relative to, the second housing, the first and second housing comprising respective first and second engagement features configured to engage each other, each of the first and second optical ferrules comprising an input surface for receiving and transmitting a central light ray from an optical component disposed proximate the optical ferrule, a light redirecting side for receiving along a first direction, the central light ray transmitted by the input surface and redirecting the received light along a different second direction, the redirected central light ray exiting the optical ferrule toward the other optical ferrule through an output surface of the optical ferrule, such that as the first and second optical connectors move from a partial to a full mating position relative to each other, an engagement between the first and second engagement features transitions from a partial engagement to a full engagement, the transition causing the first optical ferrule to move relative to the first housing.

14. The optical connector assembly of claim 13, wherein the second optical ferrule is bonded to the second housing.

15. The optical connector assembly of claim 13, wherein the optical component is an optical fiber attached to the optical ferrule.

16. The optical connector assembly of claim 13, wherein the optical component is an optical transceiver disposed proximate and facing the input surface and configured to at least one of receive light from and transmit light to the optical ferrule.
